(19) United States
(12) Patent Application Publication
(10) Pub. No.: US 2026/0270569 A1
(43) Pub. Date: Sep. 10, 2026

(54) FULL-FOCUSED PLENOPTIC OBJECTIVE MACROSCOPIC PLENOPTIC IMAGING

(71) Applicant: THE GEORGE WASHINGTON UNIVERSITY, Washington, DC (US)

(72) Inventors: Mark YAMAKATIS, Clark, NJ (US); Philippe BARDET, Washington, DC (US); Peter HUCK, Danville, CA (US); Sabine PORTAL, Arlington, VA (US)

(21) Appl. No.: 19/162,484

(22) PCT Filed: Mar. 6, 2024
(86) PCT No.: PCT/US2024/018662

§ 371 Date: Sep. 5, 2025

Related U.S. Application Data
(60) Provisional application No. 63/450,203, filed on Mar. 6, 2023.

(51) Int. Cl. H04N 23/957; H04N 23/55

(52) U.S. Cl. CPC H04N 23/957; H04N 23/55

(57) ABSTRACT

A plenoptic, or light field, imaging enables the reconstruction of the light field, and therefore of a 3D scene, from a single camera through computational imaging. The plenoptic approach is an improvement to Fourier integral microscopy, or FIMic, to macroscopic imaging. The plenoptic imaging scheme offers better spatial resolution and simpler calibration and many generic computational reconstruction schemes. The plenoptic system does not require a complex customization of a camera, but instead relies on the design of a camera objective, which greatly reduces the complexity and cost of the scheme and simplifies its deployment to many cameras.

### CROSS-REFERENCE TO RELATED APPLICATIONS

This application claims the benefit of priority of U.S. Application Ser. No. 63/450,203, filed on Mar. 6, 2023, the content of which is relied upon and incorporated herein by reference in its entirety.

### GOVERNMENT LICENSE RIGHTS

This invention was made with government support under ONR-DOD-Number N00014-20-1-2672 and Number N00014-23-2-2001 awarded by the Department of Defense. The U.S. government has certain rights in the invention.

### FIELD

This invention relates to digital imaging, specifically plenoptic or light-field imaging to reconstruct scenes in three-dimension.

### BACKGROUND

Referring to FIG. 1, a typical imaging system images an object into a sensor plane through a main lens or objective. This flattens the object scene into a two-dimensional (2D) image. A main lens or objective 100 is made of several lens elements, or groups, and a diaphragm, or aperture, which enable to project the object onto the sensor while minimizing optical aberrations. The lens elements are typically assembled into two groups: the front lens 110 and rear lens groups 120. A diaphragm or aperture 130 is typically inserted between the front lens group 110 and the rear lens group 120. There are many types of objectives 100 that use different types of lens elements and location of the aperture. For example, in an object space telecentric objective, the diaphragm is located at the back focal of the front lens group.

A light-field imaging device records multiple angles, or perspectives, from a scene. The three-dimensional (3D) scene can then be reconstructed computationally. One relatively straightforward approach to sampling the light field and reconstruct a 3D scene is to deploy multiple imaging devices (such as cameras). However, this can be inconvenient (e.g., when deployment space is limited), and can be onerous and complex needing precise synchronization, triggering, positioning, and calibration. These challenges are accentuated when the system might vibrate or cameras are displaced.

In contrast, plenoptic (latin roots ‘plen’ and ‘optic’ translating to ‘full view’) imaging permits sampling the light field using a single camera sensor, vastly simplifying deployment and reducing costs. Plenoptic imagers typically have an objective, a microlens array (MLA), and an imaging device (such as a 2D sensor, like a CCD or CMOS sensor). The MLA is typically a single optical element consisting of many lenslets that are usually 10s to 100s of micrometers in diameter in some type of pattern.

In plenoptic imaging, there is a tradeoff between spatial and angular samplings, as will be described next. FIGS. 2(a) and 2(b) show plenoptic cameras. FIG. 2(a) is the image recorded by a standard plenoptic configuration. The plenoptic information has been separated in angle and position information. See U.S. Pat. No. 725,567 to Ives; WO2007/092581 to Ng; US2007/0252074 to Ng; G. Lippmann, Epreuves reversibles donnant la sensation du relief. Journal of Physics, 7(4):821-825, 1908. Here, the MLA is placed at the image plane of the main lens, and the imager is moved back to the focal length of the MLA. Here, each pixel, 201, in the sub-aperture image 202 (or image recorded being a microlens, or microimage) corresponds to a different perspective, or angular resolution of the scene. Distinctive perspective views must be rendered, 203. In general, angular resolution is privileged and the technique suffers from poor spatial resolution and the need for high resolution (large number of pixel) imagers. This is considered to be poor for many applications.

The sensor plane 222 (typically, though not always, fₘₗₐ from the MLA plane) is conjugate with the objective lens plane 224, meaning that the objective lens 230 needs to be f/# matched to provide full angular sampling of the angular information in the light field. Additionally, f/# matching permits full use of the sensor plane with no overlapping between sub-aperture image. If satisfied, the sensor 232 behind a lenslet 234 samples the angular information spread across the objective lens 230, encoding it on the pixels found behind the lenslet 234.

In other words, each sub-aperture image 220 is made of angular information corresponding to a single point on the object 20. For a full view, the scene (lateral image) has to be reconstructed first. This angular sampling of the light-field is well represented in FIG. 2(a). It is the convention that FIG. 2(a) has the best angular resolution, and the worst spatial resolution of FIGS. 2(a), 2(b) and 3. Spatial resolution pertains to the ability to distinguish features within a 2D image of a 3D scene, or object, i.e. on an image formed by a traditional imaging system. Angular resolution relates to the angle of the light rays that are scattered from a 3D object.

FIG. 2(b) is a setup, sometimes called the focused, or multi-focused plenoptic camera system 250. See US 2009/0041448 to Georgiev; U.S. Pat. No. 8,619,177 B2 to Perwass; European Patent EP09005628.4; LUMSDAINE A. and GEORGIEV T, The focused plenoptic camera. In Proceedings of the International Conference on Computational Photography. San Francisco, CA, USA, 2009; C. Perwass and L. Wietzke, Single lens 3d-camera with extended depth-of-field. In Human Vision and Electronic Imaging XVII, volume 8291, page 829108, International Society for Optics and Photonics, 2012. FIG. 2(b) achieves higher spatial resolution than the plenoptic system of FIG. 2(a), with the reconstructed images having a spatial component of the light-field resolution at a maximum of ¼ of the camera sensor 252. In this configuration, the MLA 254 sub-samples the image 256 created by the camera lens 258. The MLA 254 is typically set at a distance A 260 from the image plane 262, and a distance B 264 from the sensor plane 266. In this configuration each micro image 268 contains more than one spatial sample, therefore increasing spatial resolution at the cost of angular information. The most advanced version of the plenoptic system 250 is the multi-focused plenoptic camera model of Perwass, Single Lens; EP09005628. The MLA 254 has three focal lengths 270, 272, 274, which increases the depth of field of the over-all imager. Perwass and Wietzke claim a resolution that is a quarter of the overall resolution at the plane farthest from the camera. Image quality is not uniform over the entire depth of field.

The angular and spatial dependence of the sampling of the light field with plenoptic 250 is well represented in FIG. 2(b). It also shows that there is redundancy between the micro-images, which can be taken advantage of to increase the lateral and depth resolutions.

Plenoptic systems have been proposed for generic infinity-corrected microscope objectives, US 2014/0209821 to Santori et al., and for 3D microscopy, WO 2008/092074 to Georgiev et al. and US 2012/0224034 to Kalkbrenner et al. It should be noted that the approach has not been extended for macroscopy imaging, which forms the basis of this application.

### SUMMARY

A plenoptic, or light field, imaging enables the reconstruction of the light field, and therefore of a 3D scene, from a single camera through computational imaging. The plenoptic approach is an improvement of Fourier integral microscopy, or FIMic, to macroscopic imaging. The plenoptic imaging scheme offers better spatial resolution and simpler calibration and many generic computational reconstruction schemes. The plenoptic system does not require a complex customization of a camera, but instead relies on a new class of camera objective, which greatly reduces the complexity and cost of the scheme and simplifies its deployment to many cameras.

This summary is not intended to identify all essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a prior art architecture of an imaging lens or objective;

FIG. 2(a) shows light field sampling by a first prior art plenoptic system;

FIG. 2(b) shows light field sampling by a second prior art plenoptic system;

FIG. 3 is an embodiment of a plenoptic system, where the object is imaged by an objective, or main lens, the lens array is placed at the back focal plane, or Fourier plane, of the main lens, and the image is recorded by the photodetector sensor;

FIG. 4 shows light field sampling by a plenoptic system in accordance with the present disclosure;

FIG. 5 is another embodiment of the plenoptic system having infinity corrected imaging;

FIG. 6 is another embodiment of the plenoptic system; and

FIG. 7 is an image from FIG. 6 having twelve perspective views of one scene from a 3×4 lens array.

The figures show illustrative embodiment(s) of the present disclosure. Other embodiments can have components of different scale. Like numbers used in the figures may be used to refer to like components. However, the use of a number to refer to a component or step in a given figure has a same structure or function when used in another figure labeled with the same number, except as otherwise noted.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

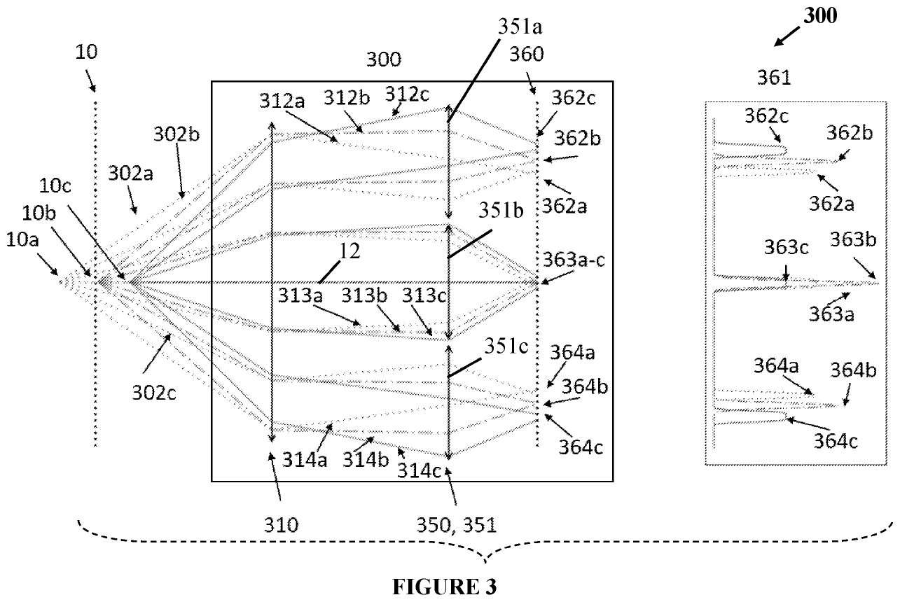

Turning to the drawings, FIG. 3 shows a plenoptic apparatus or system 300 in accordance with one illustrative, non-limiting embodiment of the present disclosure. As shown, the plenoptic system 300 has an objective or main lens 310, lens array 350, and a photodetector sensor 360. The double ended arrows used in 310 and 350 signify a lens or series of lenses and the dotted lines in 10 and 360 represented the native object and sensor planes, respectively. In the example embodiment of FIG. 3, there is a single main lens 310, and the lens array 350 has a first or top lenslet 351a, second or center lenslet 351b, and a third or bottom lenslet 351c. The center lenslet 351b is on-axis, i.e. on the optical axis of the objective 310, with the objects 10a-c; that is, along the linear optical axis 12 from the object 10 through the main lens 310 and the center lenslet 351, so that the center lenslet 351b focuses the light on the optical axis 12 at the on-axis image 363 of the image plane 360. The top and bottom lenslets 351a, c are off-axis, i.e. they are offset from the optical axis 12 of the objective 310, and focus the light at a position offset from the optical axis 12 at the off-axis images 362, 364 of the image plane 360, respectively.

In the embodiment shown, the lenslets 351 are substantially smaller than the main lens 310, and the lenslets 351 are arranged linearly and planar with one another. The lens array 350 may be slightly larger than the main lens 310, as shown, or may be slightly smaller or larger than the main lens 310. However, any suitable number of main lens 310 and/or lenslets 351 can be provided. In some embodiments, the lenslets 351a-c can be continuous and touching or slightly separated from one another (FIG. 3), or can overlap with one another, to provide a continuous coverage of light 312, 313, 314.

The native object plane 10 is at the working distance of the objective, which results in an image in focus on the sensor, or image, plane 360. Objects are typically 3D scenes that scatter or emit light. To highlight the 3D operating principle of the system and simplify the discussion, we selected an object made of three light sources, or distinct objects, 10a, 10b, and 10c, that are aligned along the optical axis of the main objective 310. However, the system is generic and can reconstruct general 3D object. The second object 10b is at the working distance of the compound system made of the objective 310 and the lens array 350, while the first object 10a is past that point and the third object 10c is closer to the objective 310.

The lens array 350 is placed at the back focal plane, also called the Fourier plane, of the main lens 310. The image is recorded by the photodetector sensor 360. The sensor 360 is located to form an image through the compounded system of the objective 310 and lens array 350. This specific configuration ensures that the formation of distinct perspective views of the object with corresponding field of view for all the microimages. An array of apertures, 351, may be added to the lens array to prevent image overlap and/or increase the depth of the field of the imager. The apertures may touch the lenslets 351 or be placed in their close proximity. The apertures may be on the left or right of the lens array.

The main objective 310 collects the cones of light 302a, 302b, and 302c for the three objects 10a, 10b, and 10c, respectively. Once the light passes the objective 310, the lens array 350 subsamples the cones into individual perspectives 312a-c, 313a-c, and 314a-c. The lens array 350 then focuses each of these cones onto the image plane 360. This is best visualized by the 1D light intensity profile 361, which is taken through the sensor plane 360. The three objects 10a, 10b, and 10c, that are aligned along the optical axis are indistinguishable on the central view 363 (i.e., the second set of on-axis images 363a, 363b, 363c are aligned with and overlap each other) acquired with an on-axis lenslet 351b; but are distinguishable on the views obtained by the off-axis views 362, 364 as 362a-c and 364a-c (i.e., the first set of off-axis images 362a, 362b, 362c are offset from one another, and the third set of off-axis images 364a, 364b, 364c are also offset from one another), respectively.

The middle images 362b, 363b, and 364b are in focus, because they were at the native working distance of the objective 310. The top and bottom images (i.e., 362a, 362c, 363a, 363c, 364a, 364c) are slightly blurred in this rendering. In practice, the level of focus is dictated by the aperture of the imager. Light or images 312a-c becomes 362a-c, which corresponds to the side view of the scene made of the objects 10a-c, respectively. Light 314a-c is a similar view, but imaged from another perspective and the order of the objects 10a-c has been flipped. Thus, the first object 10a corresponds to the images 362a, 363a, 364a; the second object 10b corresponds to the images 362b, 363b, 364b; and the third object 10c corresponds to the images 362c, 363c, 364c. In short, with the present arrangement, we obtain several images of the scene simultaneously, each at a different angle, this is equivalent to having several mini cameras imaging the scene from different points of reference. The views can be interrogated computationally to reconstruct the scene in 3D with a single camera. Because full views are formed, one can use standard tomographic or triangulation based algorithms to reconstruct the 3D scene.

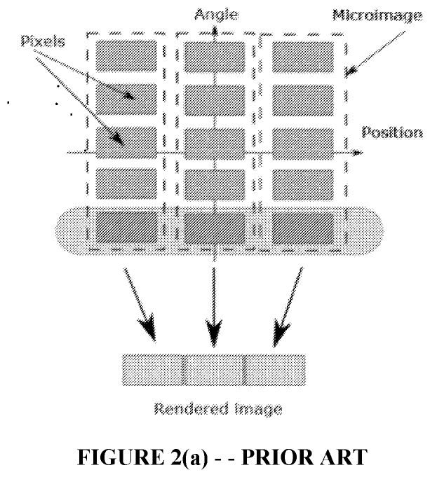

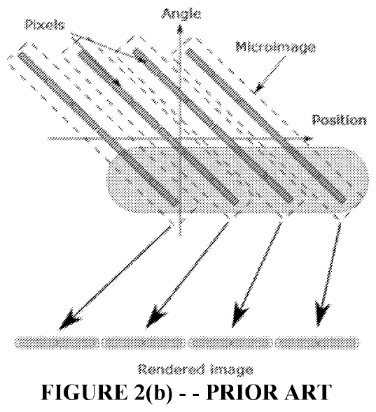

To form high spatial resolution images, the lenslets 351a-c used in the lens array 350 are significantly larger than those used for other plenoptic systems (FIGS. 2(a), 2(b)). For example, they are typically a fraction of the sensor 360 size, while in the other approach they are 10's of pixels in diameter. The larger lenses result in larger field of view and better image resolution. Principles of super resolution can be used to recover nearly half of the full sensor resolution. Multiple lenslets 351a-c are utilized to provide a plurality of respective different images 362, 363, 364 at the image plane 360, including off-axis images 362, 364 that provide offset images 362a-c, 364a-c that are distinguishable from one another. The ability to distinguish the depth of the sources, or in other words the 3D reconstruction accuracy, is directly related to how far off-axis the lenslets, which is a relation to their diameter. The lens array 350 may also contain an aperture array to increase the depth of the field of the overall imager. Finally, not all the lenslets need to have the same focal lengths, as various focal length and/or axial position increases the overall depth of field.

It is further noted that the system 300 provides full images and all the images share the same field of views, albeit viewing it from different angles, for example, at each of images 362, 363, 364 of FIG. 3. This results in high resolution and efficient computational reconstruction.

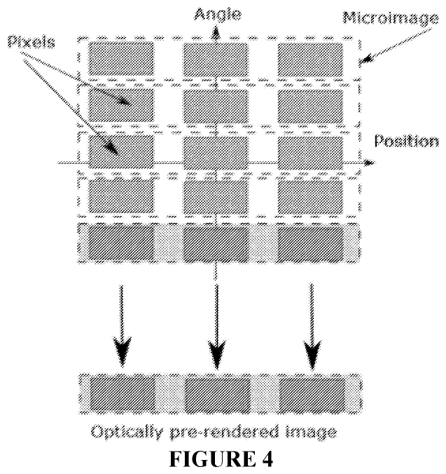

FIG. 4 shows the captured image represented in the light field. Each microimage, recorded behind each lenslet 351 is at one angular perspective and is a full image of the scene. In other words, each microimage corresponds to a view such as 362, 363, or 364 in FIG. 3.

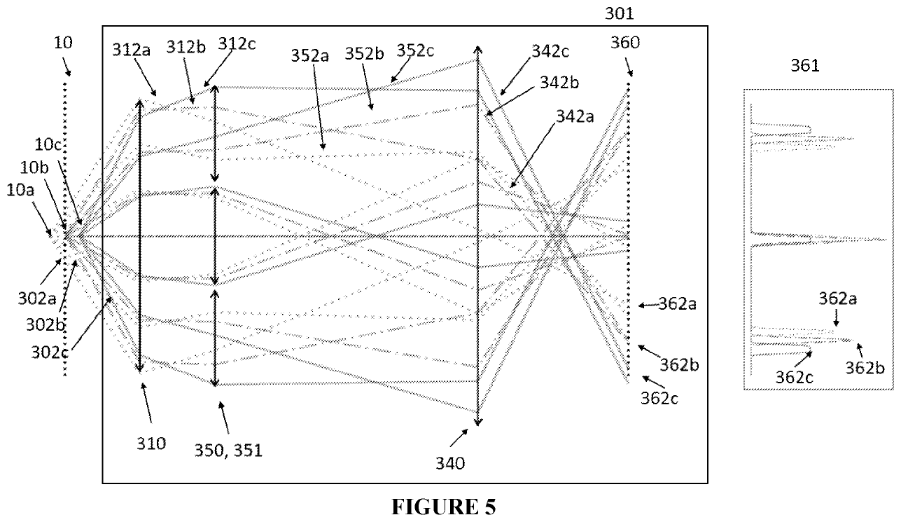

In another non-limiting example embodiment, such as the plenoptic system 301 shown in FIG. 5, the system has the same components as the plenoptic system 300 with the addition of one extra rear lens, or rear lens group 340. The rear lens group 340 enables to better control the magnification of the image on the sensor 360. The magnification will control the field of view and spatial resolution. The position of the rear lens group 340 and the sensor 360 are adjusted to accommodate the desired working distance in 310 and the desired magnification on the sensor 360. The first half of the imager until the lens array 350 is similar to FIG. 3 and the paths of light are similar. For the sake of clarity in FIG. 5, the path for only one microimage is annotated. The light rays that issue from the lens array 350, depicted as 352a-c, are focused on the sensor 360 by the rear lens 340. The rays 342a-c shows the path of the light issuing from the first lenslet 351a of the lens array.

FIG. 5 shows the plenoptic system 301 with a set of converging lenslets 351 in the lens array; however, diverging lenses can be used, the system is then more compact. In addition, the rear lens group 340 can be one or more lenses, though a single lens is shown. And, the rear lens group 340 is positioned after the lens array 350, so that light from the objects 10 pass through the main lens 310, through the lenslets 351, through the rear lens group 340, to the image plane 360. The distance from the rear lens group 340 to the image plane 360 is adjusted to obtain an image of the object 10 in focus on 360 for a given working distance of the objective 310.

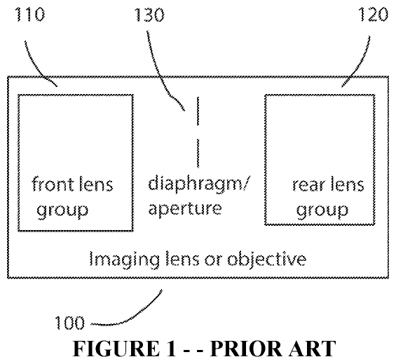

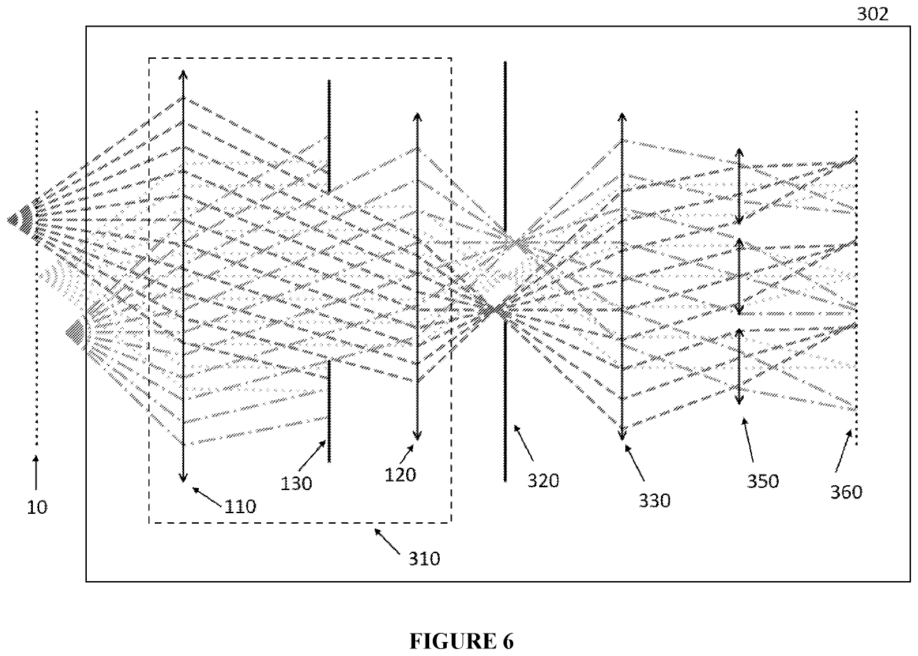

FIG. 6 shows another embodiment, such as the plenoptic system 302. The Fourier plane of the main objective lens 310 is within the objective and cannot be accessed physically. The system 302 uses a field stop 320 and a relay lens 330 to optically access the Fourier plane where the aperture of the objective is located. The front objective 310 is a similar arrangement to the main lens 100 of FIG. 1, in that it has a front element group 110, an aperture 130, and a rear lens group 120.

As shown, light from the objects 10 pass through the front lens group 110, aperture 130, then rear lens group 120, and then through the field stop 320, through the relay lens 330 and through the lens array 350 to the image plane 360. The relay lens 330 enables to optically position the lens array 350 at the Fourier plane 130 of the objective 310 since the Fourier plane cannot be accessed physically. The field stop 320 restricts the numerical aperture of each view and prevents overlap of the microimages on the sensor 360. Note in this figure the three light sources are offset laterally as well as axially to help visualize the light path. We did not have to do this in FIGS. 3 and 5 as the paths were simpler to follow on the graph.

For a given field of view, the plenoptic systems 300, 301, and 302 (FIGS. 3, 5, 6) have similar angularity than existing plenoptic systems of FIGS. 2(a), 2(b), however, they form full images with higher spatial resolution. The accuracy of the computational reconstruction of the 3D object depends on the perspective angle between the views; this is well illustrated in FIGS. 3, 5, where points that were aligned along the optical axis were distinguishable on the views generated by the off-axis lenslets forming the microimages 362 and 364. Any suitable computation can be used to reconstruct the 3D object from the images at the image plane 360. Furthermore, the accuracy of the 3D reconstruction also depends on the spatial resolution of each microimage, which enables more precise disparity between views. The new plenoptic approach has the highest spatial resolution of compared to prior plenoptic approaches and will have superior 3D reconstruction accuracy.

### Embodiments of the Invention

FIGS. 3, 5, 6 provide three non-limiting example implementations of the plenoptic systems 300, 301, 302 of the present disclosure. The lens array 350 creates angular sampling of the light field by forming off optical axis perspective views. The lens array 350 is physically located in the Fourier plane of the main objective 310, or accessed optically through a set of relay lenses 330. The distance between the sensor 360 and the lens array 350 determines the working distance of the system, i.e., where the object is physically located with respect to the front of the objective 310.

One strength of the plenoptic systems 300, 301, 302 is that no additional computational effort is required to generate perspective views that can be used with different techniques for determining disparity, or perspective effect, amongst images. In other words, we can get multiple “miniature cameras” on a single camera sensor 360. Any suitable tomographic methods can be utilized to reconstruct a 3D scene computationally from the microimages captured with 300, 301, or 302. For macro, or personal photography, this means that the user can see directly if the image in is focus by visually or computationally inspecting the microimages. This removes the need for a preview processor as necessary in the plenoptic system of FIG. 2(a).

FIG. 3 is the most fundamental approach. A high-quality lens 310 can be used, where the object 10 is in focus at the lens working distance. The lens array 350 is placed at the (rear) focal plane of the lens 310 and the sensor 360 is located at (or near) the focal point of the lens array 350. In this FIG. 3, lenslets were displaced along the diagonal, which corresponds to 7 for a 2D sensor. In practice, this number can be controlled, which will result in a compromise between spatial and angular resolutions. The more lenslets are used in the array, the more angularity we will have in the system, but each view will have lower spatial resolution.

FIG. 5 requires the revised front and/or rear lens group lenses of FIGS. 3, 5, 6 (i.e., with the lens array 350, 351 and aperture 320) due to the need to access the Fourier plane of the prime lens, i.e., positioning the lens array 350 and associated aperture array 351 within the lens. In most prime lenses, we do not have access to the focal plane of the lens. However, in camera lenses that are object telecentric, the back focal plane of the front lens element 310, also called the Fourier plane, is also the aperture plane 130. This can form the basis of one type of new camera lenses of FIGS. 3, 5, 6 (i.e., with the lens array 350, 351 and aperture 320). To obtain an image on the sensor plane 360, the rear lens group 340 should be positioned such that the sensor plane 360 is the conjugate of the lens array 350 back focal plane. As a result, the original objective 310 becomes a new objective with the lens array 350 inserted inside. If the camera lens is not object space telecentric, the camera, or prime, lens can be focused at infinity and its back focal plane is equivalent to the image plane, which does not require access to the diaphragm. This configuration offers the advantage that the magnification on the sensor plane 360 can be controlled through the rear lens 340.

This configuration is compact (almost the same size as a typical camera objective). This is a significant improvement over FIG. 6, which have long lenses due to the use of the relay lenses 330. In addition to being compact, the system has the potential to be robust and even ruggedized, which will extend its applicability and greatly simplify its deployment. It can also be deployed on standard cameras, without the need to modify the camera sensor as in plenoptic 200 and 250 approaches. In general this is preferrable as it offers more flexibility for choosing high speed vs high resolution (large number of pixels) imagers.

FIG. 6 is especially useful in the case where the aperture plane 130 is not accessible or a particular lens 310 is desired for use, such as if prime lenses are used to make the objective 310. Here, one can access the aperture plane 130 by placing a relay lens 330 between the back focal plane of the objective 310 and the lens array 350. This also allows the addition of a field stop 320 at the focal of the rear lens group 120 and relay lens 330, which can be used to control the field of view and prevent image overlap. The requirements on the size and number of lenslets are the same than discussed for FIGS. 3 and 5.

In yet another embodiment, instead of a lens array 350 with lenses of constant focal length, suitable alternatives can be provided. They include, but are not limited to, diffractive optical elements, engineered diffusers, artificial phase masks, periodic surface patterns etc. This is applicable to any of the three approaches, FIGS. 3, 5, and 6.

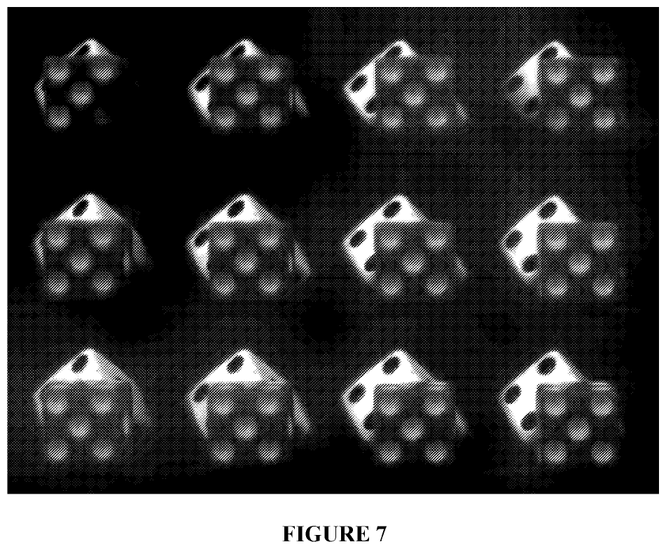

FIG. 7 shows a raw image obtained with the plenoptic system 300 (FIG. 4). A 3×4 lens array 350 is used and the raw image acquired on the sensor 360 subsequently has twelve independent microimages, or perspective views, of a scene comprising two die. In some embodiments, the 3×4 array 350 can be a planar arrangement of lenslets 351 arranged in rows and columns and aligned or offset with respect to each other. Of course, any suitable array can be utilized, having more or less than a 3×4 array. In essence, each view is equivalent a perspective effect is seen in the varying occlusion of the rear die and allows a partial reconstruction of the 3D scene computationally. Existing plenoptic approaches will not provide full images of each perspectives and will have much lower spatial resolution which will limit the overall resolution.

In some embodiments, the image plane 360 can be a photosensitive detector, such as for example a camera sensor having a charge-coupled device (CCD) array or a complementary metal-oxide semiconductor (CMOS) array, or a scientific complementary metal-oxide semiconductor (sCMOS) array, or InGAAS or photodiodes.

The plurality of lenslets 351 each provide an angular, or perspective, sample of a light field of the object at the image plane. The real images formed on the detector plane are perspective views of the object.

In addition, a data processing system can be provided using the apparatus of any of FIGS. 3, 5, 6. The data processing system includes a processing device configured to create a depth map, or 3D reconstruction, of various points found on the object using the perspective views created on the sensor. Due to the generality of the images obtained, which are similar to micro-cameras, standard tomographic or triangulation algorithms can be deployed with minimal, to no, pre-procession of the data.

The plenoptic, or light field, imaging system 300, 301, 302 enable the reconstruction of the light field, and therefore of a 3D scene, from a single camera, i.e., detector or sensor 360, through suitable computational imaging. The plenoptic approach is an improvement to Fourier integral microscopy, or FIMic, to macroscopic imaging. The plenoptic imaging scheme offers better spatial resolution and simpler calibration and many generic computational reconstruction schemes than the other plenoptic schemes. For example the resolution is 2 times larger than in plenoptic 2.0. The latter include tomographic reconstruction scheme, such as Richardson-Lucy Deconvolution, optical flow, etc. The plenoptic system does not require a complex customization of a camera, but instead relies on the design of a camera objective with the insertion of lens and aperture arrays, which greatly reduces the complexity and cost of the scheme and simplifies its deployment to many types of cameras. Typically, camera lenses cost a fraction of the cost of a camera and are less delicate to customize.

It is noted that the drawings may illustrate, and the description and claims may use geometric or relational terms, such as touch, planar, front, rear, array, group, between. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

1. A plenoptic apparatus for imaging an object, comprising:
a photosensitive detector; and
an objective lens having a front element group, a rear element group, an aperture at a back focal plane of the front element group, and a lens array co-located with the aperture to sample the Fourier plane, the lens array positioned at a back focal of the front lens group of the objective, wherein the objective lens is positioned to image the object onto the photosensitive detector.

2. The apparatus of claim 1, where the lens array is comprised of several patterned off-axis lens elements.

3. The apparatus of claim 1, having one or more photosensitive detectors.

4. The apparatus of claim 1, wherein the lens array is comprised of a plurality of lenslets.

5. The apparatus of claim 4, wherein the f/# of each lenslet is matched with the f/# of the front element group, to avoid overlap of the sub-images in the intermediate image plane.

6. The apparatus of claim 4, said apparatus comprising a plenoptic macroscopic imager, wherein said plurality of lenslets each provide an angular sample of a light field of the object at an intermediate image plane, the detector having a detector plane such that real images formed at the intermediate image plane form a series of separate real images after passing through the rear element group, wherein the real images formed on the detector plane are direct perspective views of the object.

7. The apparatus of claim 1, wherein the lens array is within the objective lens.

8. The apparatus of claim 1, wherein the specialized elements include one of a lens array of various focal lengths to increase depth of focus, a diffractive optical elements, engineered diffusers, artificial phase masks, periodic surface patterns.

9. The apparatus of claim 1, wherein said photosensitive detector comprises a camera sensor having a charge-coupled device (CCD) array or a complementary metal-oxide semiconductor (CMOS) array, or a scientific complementary metal-oxide semiconductor (sCMOS) array, or photodiode array.

10. The apparatus of claim 1, wherein the back focal plane is the Fourier plane of the front element group.

11. An apparatus, comprising:
a photosensitive detector; and
an objective having a front element group, rear element group, aperture substantially at a Fourier plane, and a specialized elements co-located with the aperture to sample the Fourier plane, the lens array positioned at the back focal of the front lens group of the objective, wherein the objective lens is positioned to image an object onto the photosensitive detector.

12. The apparatus of claim 11, wherein the specialized elements include one of a lens array of various focal lengths to increase depth of focus, a diffractive optical elements, engineered diffusers, artificial phase masks, periodic surface patterns.

13. The apparatus of claim 11, wherein the lens array is integrated into the objective lens.

14. The apparatus of claim 11, wherein said photosensitive detector comprises a camera sensor having a charge-coupled device (CCD) array or a complementary metal-oxide semiconductor (CMOS) array, or a scientific complementary metal-oxide semiconductor (sCMOS) array.

15. The apparatus of claim 11, where the apparatus has a resolution that is suitable for macroscopic imaging.

16. The apparatus of claim 11, wherein the lens array is comprised of a plurality of lenslets.

17. The apparatus of claim 16, said apparatus comprising a plenoptic macroscopic imager, wherein said plurality of lenslets each provide an angular sample of a light field of the object at an intermediate image plane, the detector having a detector plane such that real images formed at the intermediate image plane form a series of separate real images after passing through the rear element group, wherein the real images formed on the detector plane are direct perspective views of the object.
